(19) United States
(12) Patent Application Publication
(10) Pub. No.: US 2007/0207328 A1
(43) Pub. Date: Sep. 6, 2007

(54) High density thermal barrier coating

(75) Inventors: Aaron T. Frost, San Antonio, TX (US); Jose Quinones, San Antonio, TX (US)

Correspondence Address: BACHMAN & LAPOINTE, P.C. (P&W), 900 CHAPEL STREET, SUITE 1201, NEW HAVEN, CT, 06510-2802, US

(73) Assignee: United Technologies Corporation

(21) Appl. No.: 11/366,900

(22) Filed: Mar. 1, 2006

(51) Int. Cl. B32B 15/04; B32B 9/00; B32B 19/00; B05D 3/02; H05H 1/24; B05D 1/08

(52) U.S. Cl. 428/469; 428/701; 428/702; 428/472; 427/402; 427/372.2; 427/569; 427/446

(57) ABSTRACT

A process for coating an article includes the steps of applying a bond coat layer onto at least one surface of an article; applying upon said bond coat layer a thermal barrier coating composition comprising a particle size distribution of no less than about 8 microns and no more than about 88 microns; heat treating said thermal barrier coating composition at a temperature of between about 1,800° F. to 2,200° F. for about 2 hours to 4 hours at a pressure of about 1×10⁻³ torr to 1×10⁻⁶ torr; and forming a thermal barrier coating layer comprising a cracking density of no more than about twenty cracks per linear inch of said thermal barrier coating.

### FIELD OF USE

The present disclosure relates to thermal barrier coatings and, more particularly, to high density thermal barrier coatings.

### BACKGROUND OF THE INVENTION

Air plasma sprayed thermal barrier coatings (hereinafter “APS TBCs”) are well known, having been used for several decades. They are typically formed from ceramic materials capable of withstanding high temperatures and are applied to metal articles to inhibit the flow of heat into these articles. It has long been recognized that if the surface of a metal article which is exposed to a high temperature environment is coated with an appropriate refractory ceramic material, then the rate at which heat passes into and through the metal article is reduced, thereby extending its applicable service temperature range, service longevity, or both, and reducing the article's future repair costs.

Prior art APS TBCs are typically formed from powdered metal oxides such as well known compositions of yttria stabilized zirconia (YSZ). These TBCs are formed by heating a gas-propelled spray of the powdered oxide material using a plasma-spray torch, such as a DC plasma-spray torch, to a temperature at which the oxide powder particles become momentarily molten. The spray of the molten oxide particles is then directed onto a receiving metal surface or substrate, such as the surface of an article formed from a high temperature Ti-based, Ni-based, or Co-based superalloy, thereby forming a single layer of the TBC. In order to make TBCs having the necessary thicknesses, the process is repeated so as to deposit a plurality of individual layers on the surface of interest. Typical overall thicknesses of finished TBCs are generally no greater than 0.1 inches.

One well recognized problem in the use of prior art TBC coatings, particularly on articles routinely cycled from ambient conditions up to extremely high temperatures such as those used in gas turbines, is that the exposure of TBCs to the very intense heat and rapid temperature changes associated with high velocity combustion gases can cause their failure by spallation, or spalling of the TBC from the surfaces of the metal articles which they are designed to protect, possibly due to thermal fatigue. Susceptibility to spallation in cyclic thermal environments is primarily due to the existence of horizontal cracking or in-plane (of the TBC) cracking. Horizontal cracks are known particularly to increase the susceptibility of a TBC to spallation because in-plane stresses, such as in-plane stresses created during the TBC deposition process or in service, can cause such horizontal cracks to propagate and grow.

It is known that the spallation resistance of TBCs in such environments can be improved by modifying certain characteristics of the coatings. For example, it is known that the performance of yttria stabilized zirconia (YSZ) TBCs is enhanced in cyclic thermal environments by developing a predominance of cracks normal to the TBC/metal article interface (i.e. vertical cracks) and a minimum of cracks parallel to such interface (i.e. horizontal cracks). Referring to another example in a microphotograph of FIG. 1, U.S. Pat. No. 5,073,433 issued to Taylor teaches that the existence of homogeneously dispersed vertical macrocracking with a controlled amount of horizontal cracking within a TBC reduces the tendency for spalling within the coating, and thus increases the thermal fatigue resistance. Referring to yet another example in a microphotograph of FIG. 2, U.S. Pat. No. 5,830,586 issued to Gray that the extending the directional solidification of continuous columnar grains in at least one layer of a TBC promotes a coherent, continuous columnar grain microstructure and reduces the tendency for spalling within the coating, and thus increases the thermal fatigue resistance. However, neither Taylor nor Gray considers improving the density and porosity as well, which allow oxygen to permeate the bond coat and cause spallation.

Consequently, there exists a need for a high density thermal barrier coating that possesses a density, cracking density and porosity sufficient to reduce spallation.

### SUMMARY OF THE INVENTION

In accordance with the present invention, a process for coating an article broadly comprises applying a bond coat layer onto at least one surface of an article; applying upon said bond coat layer a thermal barrier coating composition comprising a particle size distribution of no less than about 8 microns and no more than about 88 microns; heat treating said thermal barrier coating composition at a temperature of between about 1,800° F. to 2,200° F. for about 2 hours to 4 hours at a pressure of about 1×10⁻³ torr to 1×10⁻⁶ torr; and forming a thermal barrier coating layer comprising a cracking density of no more than about twenty cracks per linear inch of said thermal barrier coating.

In another aspect of the present invention, a coated article broadly comprises an article having at least one surface; a bond coat layer disposed upon said at least one surface; and a thermal barrier coating layer disposed upon said bond coat layer, wherein said thermal barrier coating layer broadly comprises a heat treated thermal barrier coating composition having a particle size distribution of no less than about 8 microns and no more than about 88 microns, wherein said thermal barrier coating layer further broadly comprises a cracking density of no more than about 20 cracks per linear inch of said thermal barrier coating.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a microphotograph of a thermal barrier coating of the prior art;

FIG. 2 is a microphotograph of a thermal barrier coating of the prior art;

FIG. 3 is a flowchart representing a process of the present invention;

FIG. 4 is a microphotograph of a 7EA First Bucket part no. GTD-111 produced by the General Electric Company coated with a non-heated treated yttria stabilized zirconia thermal barrier coating; and

FIG. 5 is a microphotograph of a 501F First Stage Blade produced by Siemens-Westinghouse coated with a heat-treated yttria stabilized zirconia thermal barrier coating.

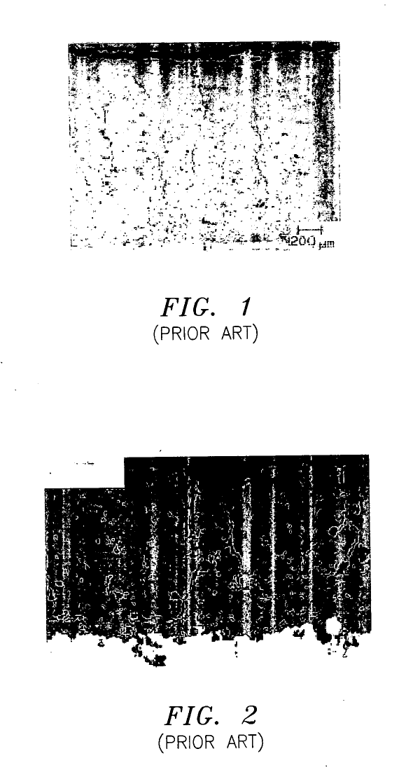

Like reference numbers and designations in the various drawings indicate like elements.

### DETAILED DESCRIPTION

Generally, the high density thermal barrier coatings of the present invention exhibit over an aggregate coating area an average density value of between about 95% to 100%, an average porosity of between no more than about 5% and 0% an average cracking density of between about 1 crack to 20 cracks per linear inch of the thermal barrier coating. The high density thermal barrier coatings of the present invention ideally exhibit a density of no less than about 98%, a corresponding porosity of no more than about 3% and a cracking density of no more than about 20 cracks per linear inch of the thermal barrier coating. While a certain amount of cracking density is good for thermal fatigue, a cracking density of greater than 20 cracks per linear inch allows oxygen to permeate the bond coat, oxidize the bond coat material and induce spallation. By increasing the coating density and reducing the amount of vertically oriented microcracks, both thermal fatigue and spallation are reduced, which actually extends the service life of the turbine engine component.

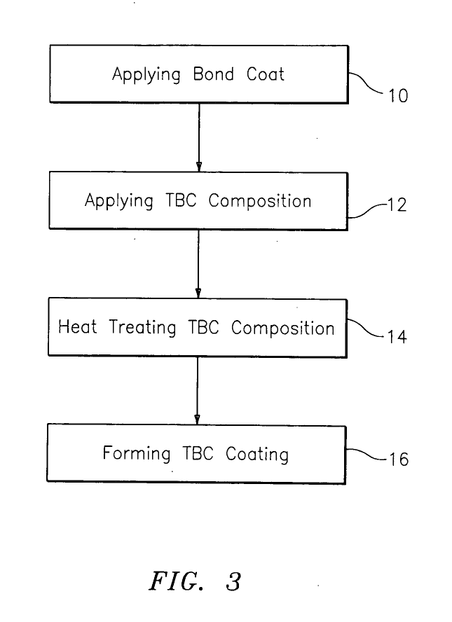

Referring now to FIG. 3, a flowchart representing the processes of the present invention is shown. An article may be provided and may be coated with a bond coat material at step 10. The bond coat material may comprise a McrAlY material. MCrAlY refers to known metal coating systems in which M denotes nickel, cobalt, iron, platinum or mixtures thereof; Cr denotes chromium; Al denotes aluminum; and Y denotes yttrium. MCrAlY materials are often known as overlay coatings because they are applied in a predetermined composition and do not interact significantly with the substrate during the deposition process. For some non-limiting examples of MCrAlY materials see U.S. Pat. No. 3,528,861 which describes a FeCrAlY coating as does U.S. Pat. No. 3,542,530. In addition, U.S. Pat. No. 3,649,225 describes a composite coating in which a layer of chromium is applied to a substrate prior to the deposition of a MCrAlY coating. U.S. Pat. No. 3,676,085 describes a CoCrAlY overlay coating while U.S. Pat. No. 3,754,903 describes a NiCoCrAlY overlay coating having particularly high ductility. U.S. Pat. No. 4,078,922 describes a cobalt base structural alloy which derives improved oxidation resistance by virtue of the presence of a combination of hafnium and yttrium. A preferred MCrAlY bond coat composition is described in U.S. Pat. No. Re. 32,121, which is assigned to the present Assignee and incorporated herein by reference, as having a general formula of MCrAlYHfSi and a weight percent compositional range of 5-40 Cr, 8-35 Al, 0.1-2.0 Y, 0.1-7 Si, 0.1-2.0 Hf, balance selected from the group consisting of Ni, Co, Fe and mixtures thereof. See also U.S. Pat. No. 3,928,026 and U.S. Pat. No. 4,585,481, which are also assigned to the present Assignee and are both incorporated herein by reference.

The bond coat material may also comprise Al, PtAl and the like, that are often known in the art as diffusion coatings. In addition, the bond coat material may also comprise Al, PtAl, MCrAlY as described above, and the like, that are often known in the art as cathodic arc coatings.

These bond coat materials may be applied by any method capable of producing a dense, uniform, adherent coating of the desired composition, such as, but not limited to, an overlay bond coat, diffusion bond coat, cathodic arc bond coat, etc. Such techniques may include, but are not limited to, diffusion processes (e.g., inward, outward, etc.), low pressure plasma-spray, air plasma-spray, sputtering, cathodic arc, electron beam physical vapor deposition, high velocity plasma spray techniques (e.g., HVOF, HVAF), combustion processes, wire spray techniques, laser beam cladding, electron beam cladding, etc. The bond coat materials may be applied to any suitable thickness for the purpose of the intended application as will be recognized by one of ordinary skill in the art.

After applying the bond coat layer to the article at step 10, the article may be coated with a thermal barrier composition (hereinafter “TBC composition”) at a step 12 of FIG. 3. The article may comprise any part that is typically coated with a thermal barrier compound and, in particular, may comprise a part used in turbomachinery applications such as, but not limited to, any part having an airfoil, any part having a seal, including blades, vanes, stators, mid-turbine frame, fans, compressors, turbine casings, seals, plates, rings, combustor panels, combustor chambers, combustor bulkhead shields, disk side plates, fuel nozzle guides and the like. The article may comprise a nickel based superalloy, a cobalt based superalloy, a ferrous alloy such as steel, a titanium alloy, a copper alloy and combinations thereof.

The TBC composition may comprise a ceramic based compound for use with turbomachinery applications as known to one of ordinary skill in the art. Representative thermal barrier compounds include, but are not limited to, any stabilized zirconate, any stabilized hafnate, combinations comprising at least one of the foregoing compounds, and the like, for example, yttria stabilized zirconia, calcia stabilized zirconia, magnesia stabilized zirconia, yttria stabilized hafnia, calcia stabilized hafnia and magnesia stabilized hafnia. Preferably, yttria stabilized zirconia may be employed. Yttria stabilized zirconia is commercially available as 7YSZ®. To achieve the desired properties, for example, aforementioned density, cracking density and porosity values, the TBC composition comprises a powder having a fine particle size distribution of no less than about 8 microns and no more than about 88 microns. For example, the TBC composition may be a powdered yttria stabilized zirconia having a particle size distribution of no less than about 8 microns and no more than about 88 microns.

One of ordinary skill in the art will recognize thermal barrier coatings of the present invention may be applied using any number of techniques such as, but not limited to, plasma spray processes, low pressure plasma-spray, air plasma-spray, sputtering, cathodic arc, electron beam physical vapor deposition, high velocity plasma spray techniques (e.g., HVOF, HVAF), combustion processes, wire spray techniques, laser beam cladding, electron beam cladding, combinations comprising at least one of the foregoing techniques, and the like.

To achieve the desired density, cracking density and porosity properties the TBC composition may be applied using air plasma spray processes known to one of ordinary skill in the art. Preferably, the air plasma spray process is performed using an internally injected powder feeding mechanism such that the powdered TBC composition may feed directly into the plume of the plasma flame as the powder is being deposited. The air plasma spray apparatus may be operated at a current of between about 600 and 1000 amps to achieve the desired plasma flame temperature. Suitable internally injected powder feeding plasma spray apparatus include, but are not limited to, the Praxair SG-100 plasma spray gun, commercially available from Praxair, Inc. of Danbury, Conn.

This air plasma spray deposition technique ensures the powdered TBC composition may pass through the hottest part of the plasma flame and melt completely. Preferably, the plasma spray gun of the plasma spray apparatus may be positioned at between about 2 inches to 8 inches away from the surface of the article being coated. This distance ensures the melted TBC composition may be deposited upon the article as quickly as possible, thus preventing the melted TBC composition from absorbing an amount of oxygen sufficient to affect the resultant TBC coating properties. To further ensure the melted TBC composition may be deposited upon the article the plasma spray apparatus may employ an arc gas mixture composed of helium and argon in a ratio of between about 3:1 to 1:3 depending upon the operating conditions. As understood by one of ordinary skill in the art helium gas is lighter than argon and moves more quickly, which actually causes the melted TBC composition particles to travel more quickly. Again, the melted TBC composition particles' increased velocity further ensure the melted TBC composition does not absorb an amount of oxygen sufficient to affect the resultant TBC coating properties.

After applying the TBC composition, the article may be heat treated at a step 14 of FIG. 3 to form the thermal barrier composition coating layer (hereinafter “TBC coating”) at a step 16 of FIG. 3. The article may be heat treated under a vacuum of about 1×10⁻³ torr to 1×10⁻⁶ torr at a temperature range of about 1,800° F. to 2,200° F. for a time period of about 2 hours to 4 hours, or a temperature of about 1,800° F. for about 4 hours, preferably at a temperature of about 2,175° F. for about 2 hours, and most preferably at a temperature of about 2,050° F. for about 2 hours. The temperature and amount of time heat may be applied is dependent upon the composition of the substrate of the article as is recognized by one of ordinary skill in the art. Suitable vacuum furnaces for use herein include any vacuum furnaces known to one of ordinary skill in the art.

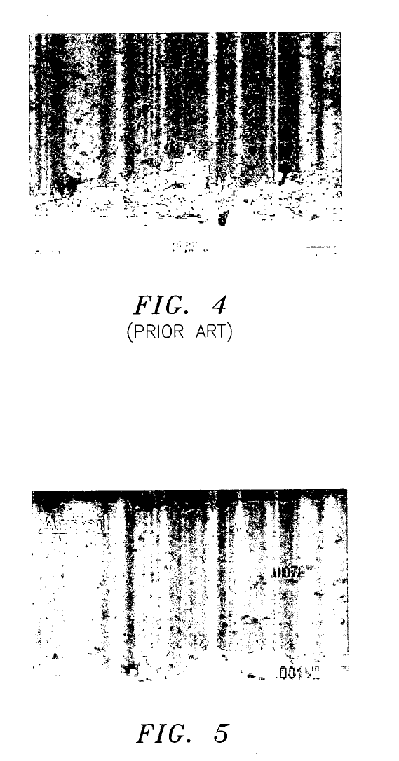

Referring now to FIG. 4, a microphotograph of a 7EA First Bucket, part number GTD-111 manufactured by the General Electric Company, is shown. The 7EA First Bucket part was coated in accordance with prior art processes, that is, the thermal barrier coating composition being applied was a coarse powder, a mixture of Ar and H gases were employed and the coatings were applied under conventional process conditions using a conventional plasma spray technique. The 7EA First Bucket part (hereinafter “7EA part”) was coated with a metallic bond coat and a thermal barrier coating of yttria stabilized zirconia having a particle size distribution of −200 mesh to 400 mesh. The yttria stabilized zirconia was applied using an internal powder injection plasma spray gun at a distance of 130 millimeters (5.12 inches), at a current of 600 amps and an arc gas flow rate of 46 liters per minute of Ar and 14 liters per minute of H. The coated 7EA part was then examined and determined to possess over an aggregate coating area an aggregate density of 90%, an aggregate porosity of 12.2% and an aggregate cracking density of 0 cracks per inch.

Referring now to FIG. 5, a microphotograph of a 501F First Stage Blade manufactured by Siemens-Westinghouse is shown. The 501F First Stage Blade part was coated utilizing a method and coating composition of the present invention. The 501F First Stage Blade part (hereinafter “501F part”) was coated with a metallic bond coat and a thermal barrier coating of yttria stabilized zirconia having a particle size distribution of −325 mesh. The yttria stabilized zirconia was applied under a vacuum of 1×10⁻³ torr to 1×10⁻⁶ torr using an internal powder injection plasma spray gun at a distance of 102 millimeters (4 inches), at a current of 1000 amps and an arc gas flow rate of 50 standard cubic feet per hour of Ar and 100 standard cubic feet per hour of He. The 501F part having the TBC layer was then heat treated at a temperature of 2,050° F. for a period of 2 hours. The coated 501F part was then examined and determined to possess over an aggregate coating area an aggregate density of 99.1%, an aggregate porosity of 1% and an aggregate cracking density of 6.66 cracks per inch.

When comparing the results shown in FIGS. 4 and 5, the TBC of FIG. 5 applied using a method of the present invention exhibit overall improved properties than the TBC of FIG. 4 applied using a conventional method of the prior art. The TBC of FIG. 4 exhibits a porosity of 12.1% that will permit an oxygen source, e.g., the atmosphere, to infiltrate and permeate the TBC coating. The TBC coating of FIG. 4 will spall and fall off the 7EA part much earlier than anticipated during its useful service life. On the other hand, the TBC coating of FIG. 5 exhibits an aggregate porosity of 1% which suggests the average porosity of the TBC coating may be in a range of 98% to 100% at any given location. This porosity value ensures an oxygen source will not infiltrate and permeate the TBC coating as readily as the TBC shown in FIG. 4. As a result, the 501F part may be in service for a greater period of time, undergo less maintenance due to TBC related problems and incur fewer maintenance related costs.

The high density TBC coatings of the present invention, and their process(es) of application, provide many advantages over prior art processes. The resultant TBC coating possesses a cracking density of typically zero. Prior art TBC coatings exhibit 20 to 200 cracks per linear inch of coating, and typically exhibit 75 cracks per linear inch of coating. As a direct result, prior art TBC coatings also fail to exhibit a density greater than 98% due to the greater number of cracks per linear square inch of coating. In contrast, the TBC coatings of the present invention exhibit a density of no less than about 98%, which corresponds to a porosity of no more than about 3%, preferably no more than about 2%, and most preferably no more than about 1%.

It is to be understood that the invention is not limited to the illustrations described and shown herein, which are deemed to be merely illustrative of the best modes of carrying out the invention, and which are susceptible to modification of form, size, arrangement of parts, and details of operation. The invention rather is intended to encompass all such modifications which are within its spirit and scope as defined by the claims.

What is claimed is:

1. A process for coating an article, comprising:
applying a bond coat layer onto at least one surface of an article;
applying upon said bond coat layer a thermal barrier coating composition comprising a particle size distribution of no less than about 8 microns and no more than about 88 microns;
heat treating said thermal barrier coating composition at a temperature of between about 1,800° F. to 2,200° F. for about 2 hours to 4 hours at a pressure of about 1×10⁻³ torr to 1×10⁻⁶ torr; and
forming a thermal barrier coating layer comprising a cracking density of no more than about twenty cracks per linear inch of said thermal barrier coating.

2. The process of claim 1, wherein the heat treating step comprises heat treating said thermal barrier coating composition under said vacuum at a temperature of about 2,175° F. for about 2 hours.

3. The process of claim 2, wherein the heat treatment step comprises heat treating said thermal barrier coating composition under said vacuum at a temperature of about 2,050° F. for about 2 hours.

4. The process of claim 1, wherein the heat treating step comprises heat treating said thermal barrier coating composition under said vacuum at a temperature of about 1,800° F. for about 4 hours.

5. The process of claim 1, wherein the heat treating step comprises heat treating said thermal barrier coating composition under said vacuum at a temperature of about 2,100° F. for about 4 hours.

6. The process of claim 1, wherein the application step of said bond coat layer comprises a process selected from the group consisting of plasma spray processes, low pressure plasma-spray processes, air plasma-spray processes, sputtering processes, cathodic arc processes, electron beam physical vapor deposition processes, high velocity plasma spray processes, combustion processes, wire spray processes, laser beam cladding processes and electron beam cladding processes.

7. The process of claim 1, wherein the application step of said thermal barrier coating composition comprises applying said thermal barrier coating composition using a plasma spray process.

8. The process of claim 7, wherein the application step of comprises using an arc gas comprising helium and argon present in a ratio of about 3:1 to 1:3.

9. The process of claim 7, wherein the application step comprises using an internal powder injection plasma spray gun.

10. The process of claim 9, further comprising operating said internal powder injection plasma spray gun at a current of between about 600 to 1000 amps.

11. The process of claim 9, further comprising operating said internal powder injection plasma spray gun at a distance of about 2 inches to 8 inches from said at least one surface of said article.

12. The process of claim 1, wherein the providing step of said thermal barrier coating composition comprises providing a powdered ceramic material selected from the group consisting of yttria stabilized zirconia, calcia stabilized zirconia, magnesia stabilized zirconia, yttria stabilized hafnia, calcia stabilized hafnia and magnesia stabilized hafnia.

13. The process of claim 1, wherein the providing step of said thermal barrier coating composition comprising providing a yttria stabilized zirconia powder.

14. The process of claim 1, wherein the application step of said bond coat layer comprises an application process selected from the group consisting of diffusion processes, low pressure plasma spray processes, air plasma spray processes, sputtering processes, cathodic arc processes, physical vapor deposition processes, high velocity plasma spray processes, combustion processes, wire spray processes, laser beam cladding processes and electron beam cladding processes.

15. A coated article, comprising:
an article having at least one surface;
a bond coat layer disposed upon said at least one surface; and
a thermal barrier coating layer disposed upon said bond coat layer,
wherein said thermal barrier coating layer comprises a heat treated thermal barrier coating composition having a particle size distribution of no less than about 8 microns and no more than about 88 microns,
wherein said thermal barrier coating layer further comprises a cracking density of no more than about 20 cracks per linear inch of said thermal barrier coating.

16. The coated article of claim 15, wherein said thermal barrier coating layer comprises a porosity of no more than about 3 percent.

17. The coated article of claim 15, wherein said thermal barrier coating layer comprises a density of no less than about 98 percent.

18. The coated article of claim 15, wherein said thermal barrier coating layer includes a thermal barrier coating composition comprising a heat treated yttria stabilized zirconia powder.

19. The coated article of claim 15, wherein said article comprises a gas turbine engine component.

20. The coated article of claim 19, wherein said gas turbine engine component is selected from the group consisting of blades, vanes, stators, mid-turbine frame, fans, compressors, turbine casings, seals, plates, rings, combustor panels, combustor chambers, combustor bulkhead shields, disk side plates and fuel nozzle guides.

21. The coated article of claim 15, wherein said bond coat layer comprises a bond coat material comprising a formula MCrAlY, wherein said M is a metal selected from the group consisting of nickel, cobalt, iron and mixtures thereof.

22. The coated article of claim 15, wherein said bond coat layer comprises a bond coat material selected from the group consisting of aluminum, platinum and mixtures thereof.

23. The coated article of claim 15, wherein said bond coat layer comprises a bond coat material selected from the group consisting of aluminum, platinum and MCrAlY, wherein said M of said MCrAlY is a metal selected from the group consisting of nickel, cobalt, iron and mixtures thereof.

24. The coated article of claim 15, wherein said bond coat layer comprises a bond coat material comprising a formula MCrAlYHfSi, wherein said M of said MCrAlYHfSi is a metal selected from the group consisting of nickel, cobalt, iron and mixtures thereof.
